(19) United States
(12) Patent Application Publication
(10) Pub. No.: US 2009/0261744 A1
(43) Pub. Date: Oct. 22, 2009

(54) Phase-control dimming electronic ballast system and control method thereof

(76) Inventors: Yu-Kai Chen, Chiayi City (TW); Yung Chun Wu, Kaohsiung City (TW); Wen-Yang Wang, Nantou City (TW); Chin-Hsiung Chang, Wufong Township (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 12/216,656

(22) Filed: Jul. 9, 2008

(30) Foreign Application Priority Data
Apr. 21, 2008 (TW) 97114441

(51) Int. Cl. H05B 37/02

(52) U.S. Cl. 315/199

(57) ABSTRACT

A phase-control dimming electronic ballast system and the control method thereof, wherein the system includes a phase controller, a converter, an inverter and a system controller. Moreover, the system controller senses a firing angle from the phase controller, and adjusts the output voltage of the converter and the switching frequency of the inverter to achieve the operation of dimming fluorescent lamp.

### BACKGROUND OF THE INVENTION

1. Field of the Invention

The present relates to a phase-control dimming electronic ballast system and control method thereof; in particular, to a control system and control method thereof for linear light dimming of a fluorescent lamp by means of detecting the phase firing angle of an input power.

2. Description of Related Art

In today's age, demand for lighting is not merely limited to whether the lighting is sufficient, but also needs to consider the ability for lighting adjustment based on the environmental requirements, as well as reduction of unnecessary energy consumption, thus the development of adjustable lighting system has now become desirable.

Currently, the approaches for fluorescent lamp lighting adjustment comprise frequency modulation, voltage modulation and duty cycle modulation. FIG. 1A shows an architectural diagram of a frequency modulation light dimming electronic ballast system. FIG. 1B shows an architectural diagram of a voltage modulation light dimming electronic ballast system. FIG. 1C shows an architectural diagram of a duty cycle modulation light dimming electronic ballast system. FIG. 1D shows a TRIAC phase-control light dimming electronic ballast system; wherein TRIAC stands for Triode for Alternating Current and is approximately equivalent to two silicon-controlled rectifiers (SCRs/thristors) joined in inverse parallel (paralleled but with the polarity reversed) and with their gates connected together. Which results in a bi-directional electronic switch which can conduct current in either direction when it is triggered (turned on).

Herein the approaches of frequency modulation, voltage modulation and duty cycle modulation all require allocation of corresponding light dimming control circuits, such as frequency modulation controller 10 (FIG. 1A), voltage modulation controller 12 (FIG. 1B) and duty cycle modulation controller 14 (FIG. 1C). From the descriptions illustrated supra, the frequency modulation controller 10 and the duty cycle modulation controller 14 both control the switching of power switches S1, S2 based on a light dimming signal SL, so as to adjust the lighting of a lamp. The voltage modulation controller 12 on the other hand, based on a light dimming signal SL, controls a power converter 11 to provide voltage conversion, so as to adjust the lighting of a lamp. Therefore, the aforementioned light dimming control circuit may cause extra loads. On the other hand, adding thyristors based TRIAC at the input AC power source and using phase modulation approach does not increase wiring loads.

In many countries, United States in particular, using thyristors based TRIAC to control input power for acting as light dimming control is relatively common, and generally applied in light dimming features of incandescent lamps. However, incandescent lamps are characterized by low lighting efficiency, which leads to unnecessary energy consumption; hence, incandescent lamps are gradually replaced by fluorescent lamps.

Whereas, since fluorescent lamps are gaseous discharge lamps, whose lighting mechanism is different from the incandescent lamps, so while incandescent lamps can emit light simply by heating the filament with small amount of current flowing through the filament, but gaseous discharge lamps on the other hand rely on continuous dissociation and association processes of mercury gas atoms inside the lamp to generate light. When starting up a gaseous discharge lamp, it requires high voltage on both sides of the lamp tube to dissociate mercury atom to enable lamp lighting, and such high voltage may be over hundreds or even up to one thousand volts.

As a result, when applying thyristors based TRIAC to light dimming control applications, use of incandescent lamp as loads will not cause lamp lighting failure situations; but in the case of using fluorescent lamp as loads, contrarily, might cause lamp lighting failure due to excessively high firing angle in thyristor based TRIAC, thus leading to voltage inputted to fluorescent lamp becoming too low, and problems of fluorescent lamp lighting failure, such as dimming range becoming overly small and power factor reduction may occur.

Furthermore, since the conductance and cut-off features in the thyristor based component TRIAC can be easily affected by load characteristics, while incandescent lamps on the other hand may act as resistive load, so that it is then less complicated to control incandescent lamp brightness, which has wider light adjustment range and linearly variable capability. However, if a fluorescent lamp is used in combination with traditional thyristor based TRIAC electronic ballast device, then, in the operation of power source with low frequencies 60 Hz or 50 Hz, the characteristics of fluorescent lamp is not resistive, lamp current is not of sinusoid wave, but with serious mutation, and the actual conductance angle of the thyristor based TRIAC will be influenced, thus restricting the dimming feature thereof.

Therefore, the use of thyristor based TRIAC for phase-control fluorescent lamp light dimming may encounter the following issues: 1. fluorescent lamp may fail to start up with higher firing angle in thyristor based TRIAC; 2. reduced power factor, smaller light dimming range; 3. non-linear lamp dimming variation, difficulty in adjustment to required brightness; 4. at low brightness, characteristics of poor dimming linearity and non-zero voltage switching may occur.

### SUMMARY OF THE INVENTION

In view of the aforementioned issues, the present invention provides a phase-control dimming electronic ballast system and control method thereof, which uses, after the phase controller, a converter, an inverter and a system controller to resolve or improve the above-described issues of fluorescent lamp lighting with traditional thyristor based TRIAC phase control.

The phase-control dimming electronic ballast system is used to linearly adjust lamp light, comprising a phase controller, a system controller, a rectifier, a converter and an inverter; wherein the phase controller adjusts the magnitude of an alternating current (AC) voltage based on a phase firing angle. The system controller is coupled to the phase controller, used for detecting the phase firing angle and outputting a pulse width modulation (PWM) signal and a high frequency signal based on the detected phase firing angle. The rectifier is coupled to the phase controller, used for AC voltage rectification and outputting an input voltage. The converter is coupled between the system controller and the rectifier, controlled by the PWM signal and modulating the inputted voltage into a direct current (DC) chain voltage by means of voltage modulation approach. The inverter is coupled to the system controller, the converter and the lamp, controlled by the high frequency signal and modulating the DC chain voltage into a lamp voltage through frequency modulation approach for use by the lamp.

From the descriptions illustrated supra, the phase-control dimming electronic ballast system, upon light dimming, uses the magnitude of modulated DC chain voltage and switching frequency as the light dimming control, so as to expand the dimming range and improve the issues of poor light dimming feature and non-zero power switching caused by single use of frequency modulation or voltage modulation. Additionally, it properly controls the duty cycle and switching frequency, and further performs corrections on power factor.

The above-stated summary and subsequent detailed descriptions are exemplary, which are directed to further illustrate the scope claimed by the present invention. All other purposes and advantages related with the present invention will be thoroughly explained in the following descriptions and appended drawings.

### BRIEF DESCRIPTION OF THE DRAWINGS

FIG. 1A shows an architectural diagram of a frequency modulation light dimming electronic ballast system;

FIG. 1B shows an architectural diagram of a voltage modulation light dimming electronic ballast system;

FIG. 1C shows an architectural diagram of a duty cycle modulation light dimming electronic ballast system;

FIG. 1D shows a TRIAC phase-control light dimming electronic ballast system;

FIG. 2 shows a system block diagram of a phase-control dimming electronic ballast system according to the present invention;

FIG. 3 shows a circuit diagram of the phase controller according to the present invention;

FIG. 4 shows a waveform diagram of the input voltage according to the present invention;

FIG. 5 shows a relational diagram of the average voltage and the phase firing angle according to the present invention;

FIG. 6 shows a diagram of an equivalent circuit for the inverter parallel connection lamp according to the present invention;

FIG. 7 shows a relational diagram of the lamp power and the DC chain voltage according to the present invention;

FIG. 8 shows a relational diagram of the lamp power and the switching frequency of the inverter according to the present invention;

FIG. 9 shows a relational diagram of the harmonic resonance current phase and the DC chain current according to the present invention;

FIG. 10 shows a relational diagram of the harmonic resonance current phase and the switching frequency of the inverter according to the present invention;

FIG. 11A shows a relational curve diagram of the lamp power and the DC chain voltage according to the present invention;

FIG. 11B shows a relational curve diagram of the phase of the harmonic resonance current and the DC chain voltage according to the present invention;

FIG. 12 shows a measured relational curve diagram of the lamp power and the DC chain voltage according to the present invention;

FIG. 13A shows a measured waveform diagram of voltage and current in the power switch when the present invention is in full load;

FIG. 13B shows a measured waveform diagram of voltage and current in the power switch when the present invention is in light load;

FIG. 14 shows a diagram of a single-level architecture combining the converter and inverting according to the present invention; and

FIG. 15 shows a diagram of another single-level architecture combining the converter and inverting according to the present invention.

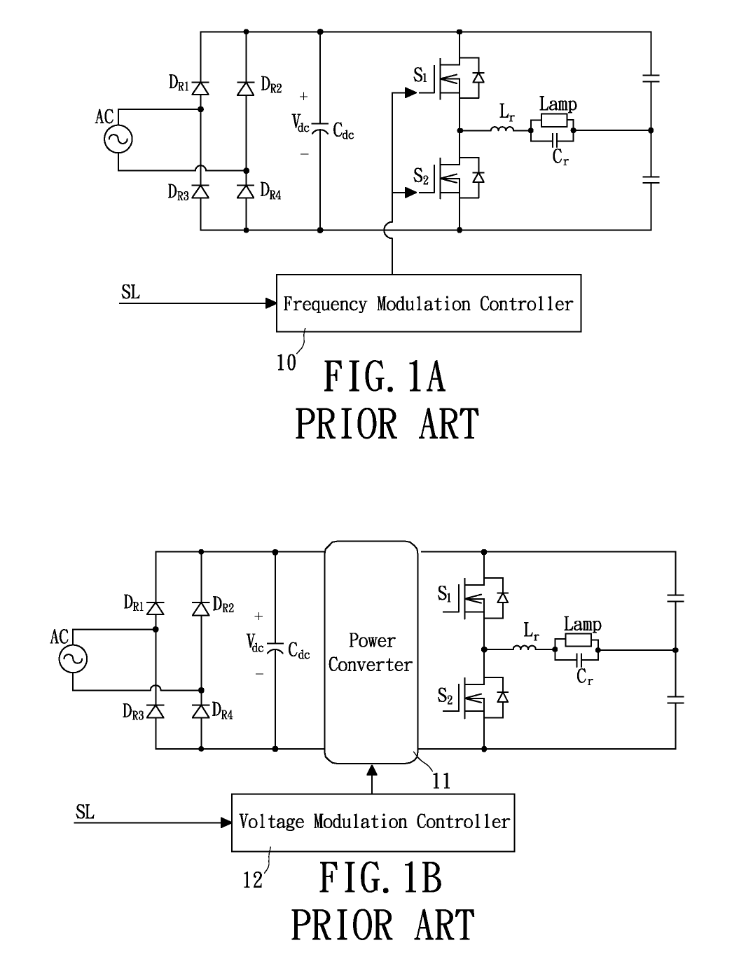

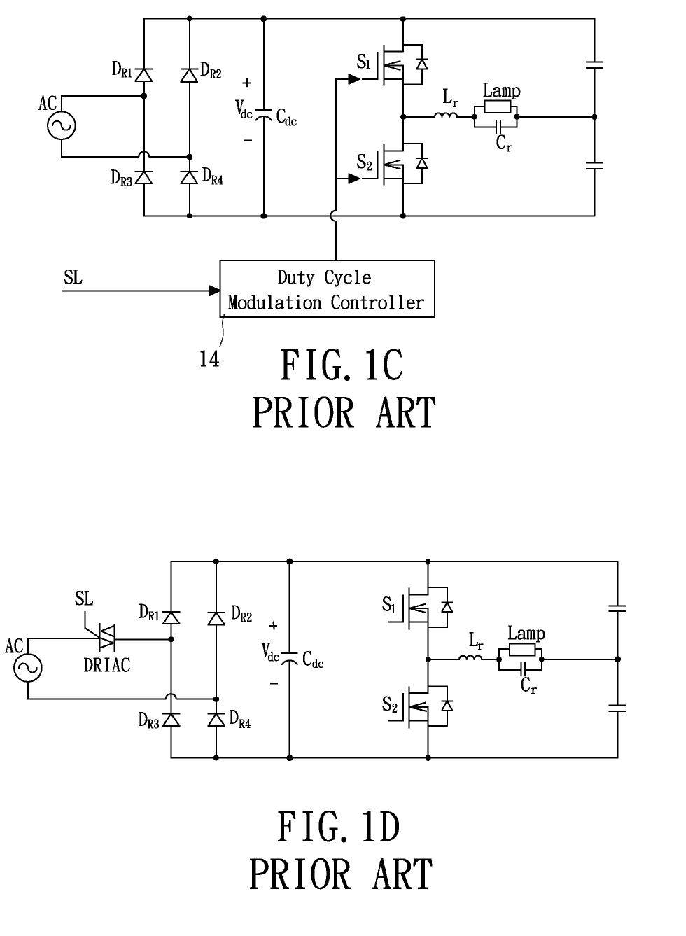

### DETAILED DESCRIPTION OF THE PREFERRED EMBODIMENTS

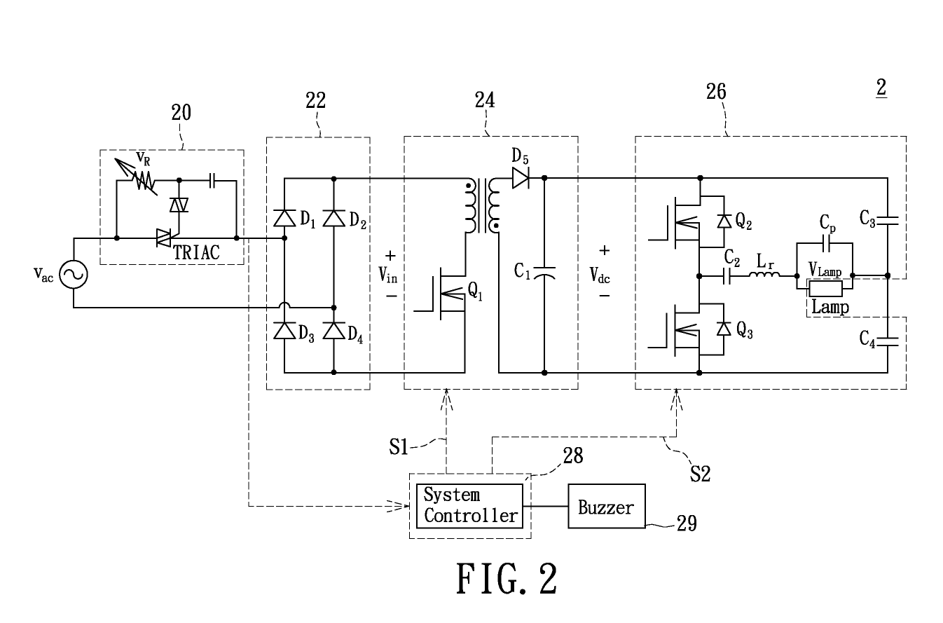

Refer now to FIG. 2, wherein a system block diagram of a phase-control dimming electronic ballast system according to the present invention is shown. The phase-control dimming electronic ballast system 2 of the present invention is used to linearly adjust the brightness of a fluorescent lamp, wherein the phase-control dimming electronic ballast system 2 comprises a phase controller 20, a rectifier 22, a converter 24, an inverter 26 and a system controller 28.

Referring again to FIG. 2, the phase controller 20 comprises a variable resistor VR and a thyristor based TRIAC, in which the phase controller 20 changes the thyristor based TRIAC by adjusting the variable resistor VR, triggering an AC voltage Vac on each half cycle of the phase firing angle α, so as to further adjust the magnitude of the AC voltage Vac based on the phase firing angle α. Meanwhile, the rectifier 22 is coupled to the phase controller 20, acquiring adjusted AC voltage Vac from the phase controller 20, and performs rectifications on the received AC voltage Vac, in order to output an input voltage Vin. Besides, the system controller 28 is coupled to the phase controller 20, detecting the phase firing angle α from the phase controller 20 and outputting a PWM signal S1 and a high frequency signal S2 based on the detected phase firing angle α.

Referring once again to FIG. 2, the converter 24 is coupled to the system controller 28 and the rectifier 22, and the converter 24 receives the PWM signal S1 from the system controller 28. The converter 24 is controlled by the PWM signal S1 and modulates the input voltage Vin into DC chain voltage Vdc by means of voltage modulation method. Additionally, the inverter 26 is coupled to the system controller 28, the converter 24 and the lamp, wherein the inverter 26 receives the high frequency signal S2 from the system controller 28 and is controlled by the high frequency signal S2, modulating the DC chain voltage Vdc into the lamp voltage V_{Lamp} by means of frequency modulation method, and the lamp voltage V_{Lamp} is the voltage supply for the lamp. Also, the system controller 28 is further coupled to a buzzer 29, and controls the operation of the buzzer 29 when the phase firing angle α is greater than a critical angle (not shown), providing in this way an acoustic warning when the brightness of the lamp reaches the lowest level.

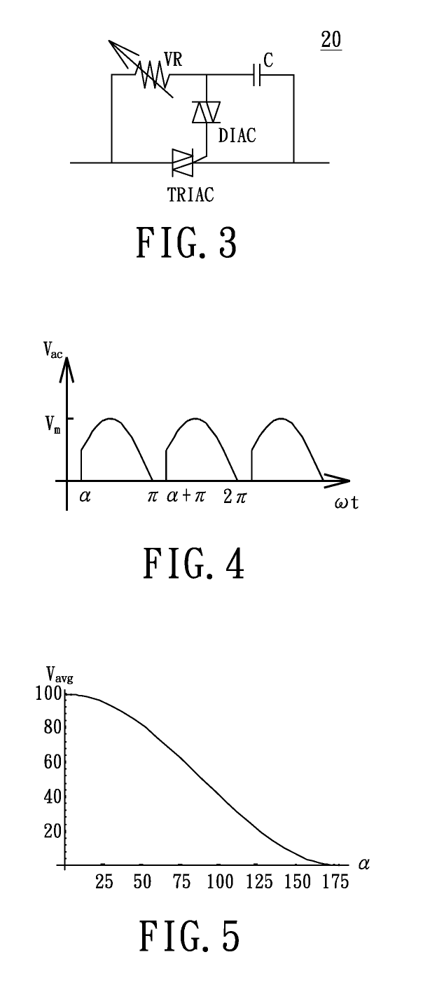

Refer now to FIG. 3, wherein a circuit diagram of the phase controller according to the present invention is shown. The phase controller 20 comprises a variable VR, a thyristor based TRIAC, a thyristor based diode for alternating current (DIAC) and a capacitor C. Therein, a thyristor based DIAC is a bidirectional trigger diode that conducts current only after its breakdown voltage has been exceeded momentarily. The phase controller 20 changes the thyristor TRIAC at the phase firing angle α of each half cycle of the AC voltage Vac essentially by adjusting the magnitude of resistance in the variable resistor VR, thereby achieving voltage control. Herein, in case the load is resistive, then the output waveform thereof is as illustrated in FIG. 4, and the average voltage Vavg outputted by the phase controller 20 can be calculated by the following formula (1):

$${V}_{avg} = \frac{{V}_{m}}{π} ( 1 + cos α ) \qquad ( 1 )$$

In formula (1), Vm is the peak voltage of the AC voltage Vac. Also, the relational curve of the average voltage Vavg outputted by the phase controller 20 and the phase firing angle α is shown in FIG. 5. As can be seen from FIG. 5, the average voltage Vavg outputted by the phase controller 20 varies depending on different phase firing angle α, thus the phase controller 20 can be used to provide the feature of light dimming in voltage modulation.

Referring back to FIG. 2, wherein the converter 24 may be a flyback converter or a boost converter. Therein, the flyback converter is a DC to DC converter with a galvanic isolation between the input and the output(s). More precisely, the flyback converter is a buck-boost converter with the inductor split to form a transformer, so that the voltage ratios are multiplied with an additional advantage of isolation; and the boost converter is a power converter with an output dc voltage greater than its input dc voltage. The converter 24 is coupled to the post-level of the phase controller 20 via the rectifier 22, which is resistive. The converter 24 acquires the input voltage Vin through the rectifier 22, so as to provide constant DC chain voltage Vdc. Additionally, when the phase firing angle α of the phase controller 20 is 0, the converter 24 is operating in Discontinuous Conducting Mode (DCM), which can be used for power factor correction, and whose relation between the input voltage Vin and the DC chain voltage Vdc can be expressed by the following formula (2):

$$\frac{{V}_{dc}}{{V}_{i n}} = \frac{D + ( \frac{{L}_{m}}{{DR}_{L} T} ) ( 1 + \sqrt{1 + \frac{2 {D}^{2} {R}_{L} T}{{L}_{m}}} )}{( \frac{{L}_{m}}{{DR}_{L} T} ) ( 1 + \sqrt{1 + \frac{2 {D}^{2} {R}_{L} T}{{L}_{m}}} )} \qquad ( 2 )$$

In formula (2), D represents the duty cycle of the power switch Q1 in the converter 24, Lm the inductance value of the converter 24, T the switching cycle of the power switch S1 in the converter 24 and R_{L} the equivalent load resistance value of the converter 24.

Although the phase controller 20 may perform light dimming function alone, however, from FIG. 5, it can be seen that the average voltage Vavg outputted by the phase controller 20 does not present linear variation depending on the phase firing angle α. As a result, in order to enable linear dimming variation, it is possible to, through the DC chain voltage Vdc outputted by the converter 24, to have a proportional relation with the phase firing angle α, as shown in formula (3):

$${V}_{dc} ∝ \frac{1}{α} \qquad ( 3 )$$

In formula (3), it is easy to see that when the phase firing angle α becomes too large, a lower DC chain voltage Vdc is generated, leading to difficulty in illumination of the lamp. Hence a possible solution is to, before starting up the lamp, first enlarge the duty cycle D of the power switch Q1 in the converter 24 to increase the DC chain voltage Vdc for facilitating the lamp illumination.

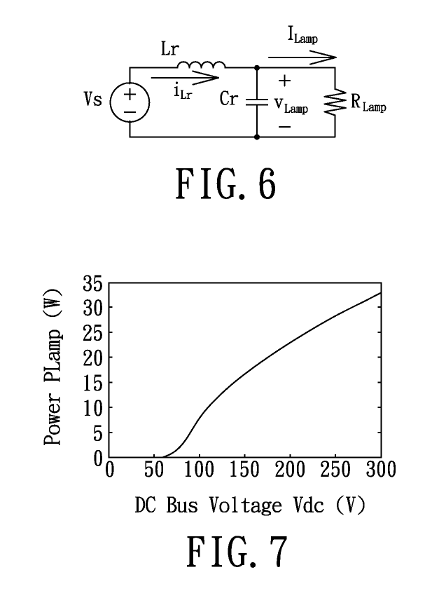

In conjunction with FIG. 2, now refer to FIG. 6, wherein a diagram of an equivalent circuit for the inverter parallel connection lamp according to the present invention is shown. The inverter 26 of the present invention is a half-bridge serial connection harmonic resonance inverter, and the said half-bridge serial connection harmonic resonance inverter 26 and the lamp are connected in parallel. As illustrated in FIG. 6, lamp voltage V_{Lamp}, lamp current I_{Lamp} and lamp power P_{Lamp} can be derived from the following formulae (4) to (6):

$$\begin{matrix}{V}_{Lamp} = \frac{{V}_{s}}{\sqrt{( 1 - {( \frac{{f}_{s}}{{f}_{o}} )}^{2} ) + {( \frac{{f}_{s}}{{f}_{o} Q} )}^{2}}} & ( 4 ) \\ {I}_{Lamp} = \frac{{V}_{Lamp}}{{R}_{Lamp}} & ( 5 ) \\ {P}_{Lamp} = \frac{{V}_{Lamp}^{2}}{{V}_{Lamp}} & ( 6 )\end{matrix}$$

In the above-mentioned formulae (4) to (6), Vs represents the mean square root of the square wave voltage (±Vdc/2), fs represents the switching frequency of the inverter 26, R_{Lamp} represents the lamp equivalent resistance, characteristic resistance is Q=R_{Lamp}/\sqrt{LᵣCᵣ}, natural frequency is fₒ=1/2π\sqrt{LᵣCᵣ}, wherein Lr is harmonic resonance inductance, Cr the harmonic resonance capacitance.

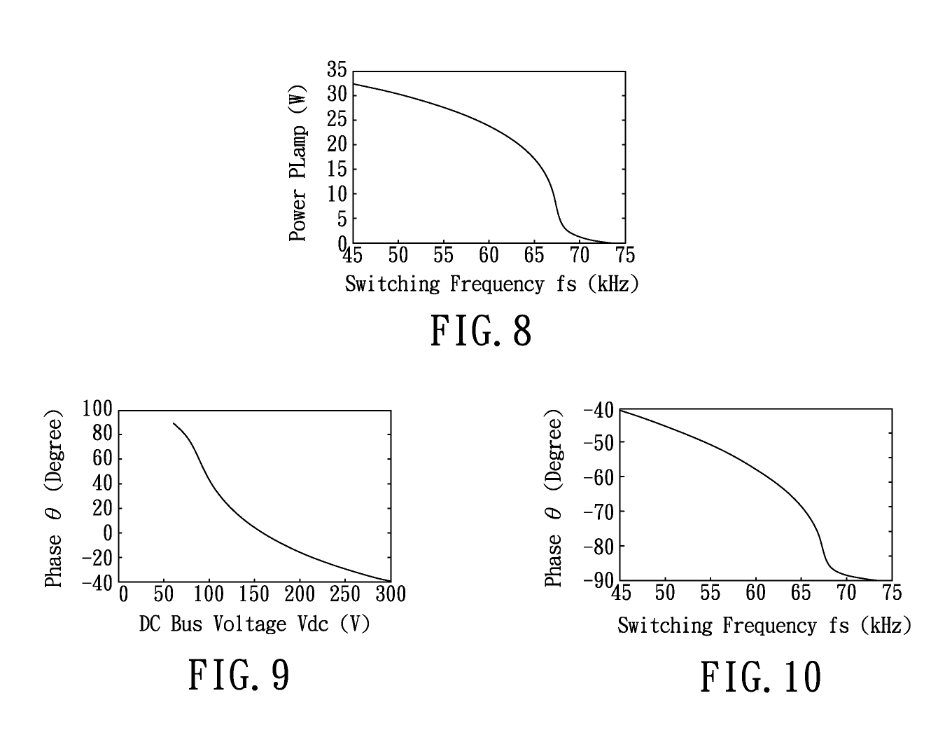

From the formulae (4) to (6), it can be seen that there exists a relationship between the lamp power P_{Lamp} and the DC chain voltage Vdc or the switching frequency fs of the inverter 26, as illustrated in FIGS. 7 or 8 (the lamp used for simulation is a fluorescent lamp of type OSRAM T8-32W), in which the relation formula thereof can be denoted as (PLamp (Vdc, fs)); thus, it is possible to modify the lamp power P_{Lamp} by adjusting the magnitude of the DC chain voltage Vdc or altering the switching frequency fs of the inverter 26, so as to provide the light dimming feature.

At the same time, if using the mean square root Vs of square wave voltage (±Vdc/2) as the reference phase, then the phase θ of current i_{Lr} of the harmonic resonance circuit can be expressed by formula (7) as below:

$$θ = - {tan}^{- 1} [ \frac{{f}_{s}}{{f}_{o} Q} ( 1 + {( \frac{{f}_{s} Q}{{f}_{o}} )}^{2} ) - \frac{{f}_{s} Q}{{f}_{o}} ] \qquad ( 7 )$$

Since the equivalent resistance R_{Lamp} of the lamp varies along with the change in the lamp power P_{Lamp}, and presents negative resistance characteristic, during the dimming process, hence, the phase θ of the harmonic resonance current i_{Lr} will alter, and the relation between the phase θ of current i_{Lr} of the harmonic resonance circuit and the DC chain voltage Vdc or the switching frequency fs of the inverter 26 can be shown in FIGS. 9 or 10.

Refer once again to FIG. 2, the system controller 28 detects the phase firing angle α from the phase controller 20, and outputs the PWM signal S1 to the converter 24 based on the detected phase firing angle α, in order to control the duty cycle of the power switch Q1 in the converter 24, which leads to the modulating of the voltage value of the DC chain voltage Vdc. Also, the system controller 28 outputs the high frequency signal S2 to the inverter 26 similarly based on the detected phase firing angle α, so as to modulate the switching frequency fs of the power switches Q2, Q3 in the inverter 26, which leads to the modulating of the magnitude of the lamp voltage V_{Lamp.} Meanwhile, by the control of the system controller 28, it allows the power switch Q1 in the converter 24 and the power switches Q2, Q3 in the inverter 26 to have the feature of zero voltage switching. Therein the zero voltage switching (ZVS) is a design feature where each switch cycle delivers a quantized ‘packet’ of energy to the converter output, and switch turn-on and turn-off occurs at zero voltage, resulting in an essentially lossless switching.

Referring again once more to FIG. 2, when the phase-control dimming electronic ballast system 2 according to the present invention starts up, the inverter 26 pauses its operations, the system controller 28 detects an initial phase firing angle α of the input voltage Vin at this moment, and furthermore outputs an initial PWM signal S1 to the converter 24, then the converter 24 modulates the input voltage Vin via a voltage modulation approach into an initial DC chain voltage Vdc, approximately 300V. Afterwards, the system controller 28 sends again the high frequency signal S2 for preheating to the inverter 26, so as to control the inverter 26 via a frequency modulation method to modulate the initial DC chain voltage Vdc, and the modulated initial DC chain voltage Vdc in turn provides the preheating lamp voltage V_{Lamp} to the lamp for preheating operation. Subsequently, the lamp is preheated for about 1 second, and the system controller 28 sends another high frequency signal S2 for startup to the inverter 26, then controls the inverter 26 via a frequency modulation method to modulate the initial DC chain voltage Vdc, so as to provide the startup lamp voltage V_{Lamp} to the lamp for illumination.

Afterwards, the system controller 28 once again detects the phase firing angle α of the input voltage Vin, and transmits a suitable PWM signal S1 and a suitable high frequency signal S2. The suitable PWM signal S1 can control the converter 24 to generate an appropriate DC chain voltage Vdc. The suitable high frequency signal S2 can control the switching of the inverter 26, allowing conversion of the appropriate DC chain voltage Vdc into the lamp voltage V_{Lamp} for use in the lamp, further achieving the objective of linear light dimming.

Based the aforementioned descriptions, upon startup, the phase-control dimming electronic ballast system 2 according to the present invention first increases the DC chain voltage Vdc to 300V, then enables the operation of the inverter 26, such that whatever the phase firing angle α of the input voltage Vin may be, the illumination of the lamp is assured, thus preventing the lamp from lighting failure which may cause malfunction in the system 2. During the operation of the system 2 according to the present invention, the system controller 28 may also check each component in the system 2 to protect functions therein, such as lamp failure protection, over-voltage protection, over-current protection and the like.

Refer now to FIGS. 7 and 9, when the DC chain voltage Vdc descends, the lamp power P_{Lamp} falls down accordingly, but the phase θ of the harmonic resonance current i_{Lr} tends to increase. Meanwhile, refer to FIG. 10, wherein the increase of switching frequency fs of the inverter 26 will further delay the phase θ of the harmonic resonance current i_{Lr}, which compensates the decrease in the DC chain voltage Vdc. Additionally, referring to FIG. 8, increasing the switching frequency fs of the inverter 26 will reduce the lamp power P_{Lamp}, but in case of wide frequency variation range (e.g. 45 kHz˜64 kHz), the variation in lamp power P_{Lamp} is not so significant, thus variation in actual lamp brightness is less noticeable. At this time, in combination with the decrease in the DC chain voltage Vdc, it will provide better linear light dimming effect.

In order to provide better linearity and more significant changes in light dimming operation of the lamp for more satisfactory and pleasing dimming effects without excessive losses, the phase-control dimming control method uses an approach of voltage modulation and frequency modulation combination, which, in dimming operation, detects the phase firing angle α of the input voltage Vin, and based on the magnitude of the phase firing angle α, modulates the DC chain voltage Vdc into the lamp voltage V_{Lamp} for the lamp, further linearly adjusting the brightness of the lamp.

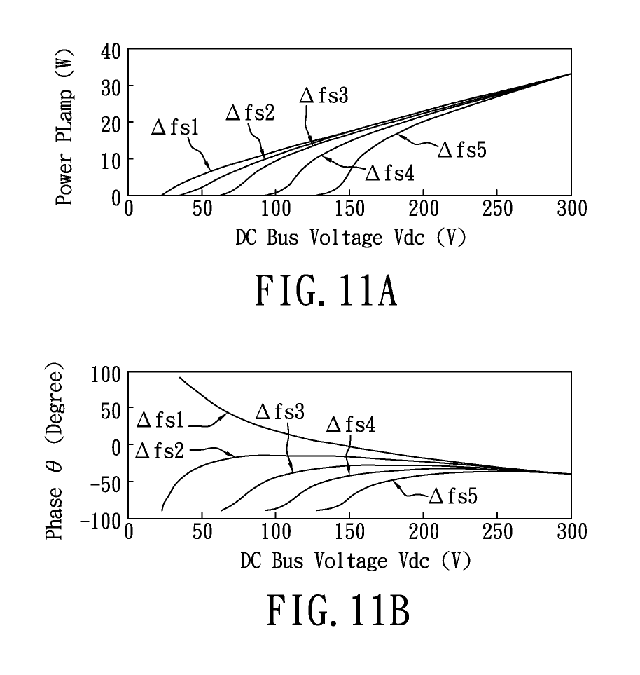

Refer now to FIG. 11A, wherein a relational curve diagram of the lamp power and the DC chain voltage according to the present invention is shown. Further refer to FIG. 11B, wherein a relational curve diagram of the phase of the harmonic resonance current and the DC chain voltage according to the present invention is shown. Herein Δfs is the increment in the switching frequency fs of the inverter for each decrement of 1V in the DC chain voltage Vdc, and Δfs1<Δfs2<Δfs3<Δfs4<Δfs5.

The phase-control dimming electronic ballast system 2 according to the present invention uses the combination of voltage modulation and frequency modulation for light dimming. Although this approach provides complementation effects, however, as shown in FIGS. 11A and 11B, during dimming operation, the phase-control dimming electronic ballast system 2 according to the present invention needs to have appropriate Δfs to perform the optimal operations. Greater amount of change in frequency Δfs will easily cause non-linear variation in lamp power; contrarily, though smaller Δfs may more likely obtain linear behavior of the variation in lamp power P_{Lamp}, but the lag in phase θ of the harmonic resonance current i_{Lr} resulted from frequency increase may not overcome the increase in phase θ of the harmonic resonance current i_{Lr} introduced by the DC chain voltage Vdc. Therefore, the phase-control dimming electronic ballast system 2 according to the present invention needs to, based on desired dimming range, select an appropriate optional curve from FIGS. 11A and 11B, so as to acquire the optimal modulation range of the DC chain voltage Vdc and frequency operable optimal range or optimal change in frequency Δfs.

It is possible to, base on the phase-control dimming electronic ballast system and the control method thereof according to the present invention, to actually fabricate an electronic dimming ballast device to perform light dimming on the OSRAM T8-32W straight tube fluorescent lamp to verify the statements disclosed in the present invention. Herein, the lamp dimming range is 100%˜10% of the lamp power; the controllable range of the phase firing angle α of the phase-controller: 45°˜135°; and variation range of relatively outputted DC chain voltage of the boost converter: 300V˜80V. When the DC chain voltage is 300V, the switching frequency of the converter fs is set to be 44 kHz; at this moment, the lamp is in full load. For each decrement of 1V in the DC chain voltage Vdc, the switching frequency fs increases 30 Hz (Δfs=30V).

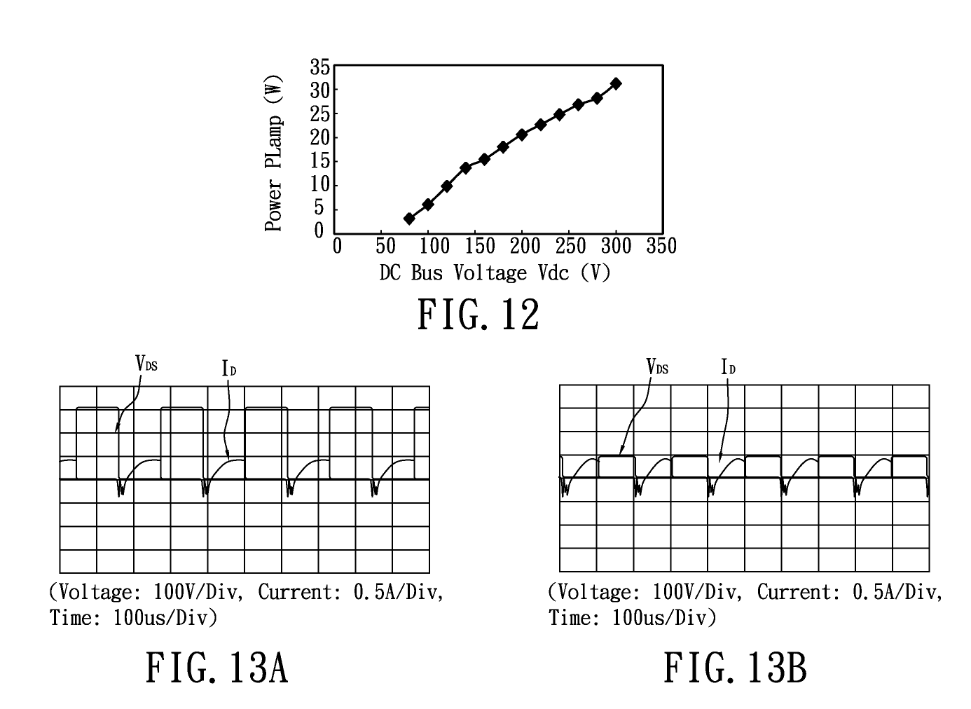

Refer now to FIG. 12, wherein a measured relational curve diagram of the lamp power and the DC chain voltage according to the present invention is shown. From FIG. 12, it can be seen that, using the combination of voltage modulation and frequency modulation as the implemented light dimming method, it present good linear relation during dimming process, facilitating convenient adjustment to any desired brightness. At the same time, FIG. 13A shows a measured waveform diagram of voltage VDS and current IDS of the power switches Q2, Q3 in the inverter 26 when the operation of the lamp according to the present invention is in full load. FIG. 13B shows a measured waveform diagram of voltage VDS and current IDS of the power switches Q2, Q3 in the inverter 26 when the operation of the lamp according to the present invention is in light load. As illustrated in FIGS. 13A and 13B, no matter in full load or in light load, the harmonic resonance networks (Lr, Cr) in the inverter 26 become inductive, and the power switches Q2, Q3 have zero-voltage switching (ZVS) feature (characterized by essentially lossless switching), thus providing higher efficiency in light dimming operation.

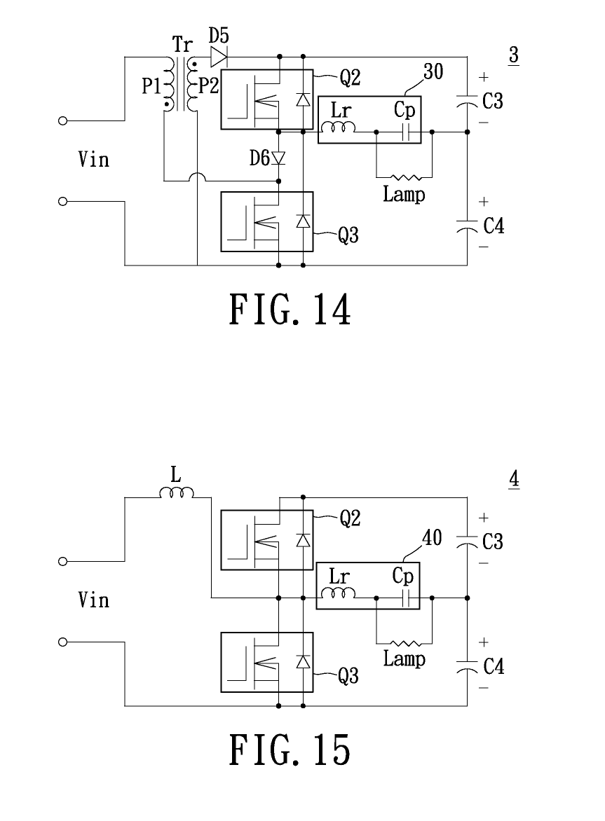

Refer now to FIG. 14, wherein a diagram of a single-level architecture combining the converter and inverting according to the present invention is shown. In FIG. 14, the depicted single-level architecture 3 combining a flyback converter and a half-bridge serial connection harmonic resonance inverter is a circuit architecture generated based on the two-level architecture shown in FIG. 2 of the flyback converter 24 and the half-bridge serial connection harmonic resonance inverter 26, through the circuit simplification principle. The said single-level architecture 3 comprises a transformer Tr, a flyback diode D5, a first switch Q2, a second switch Q3, an inductor capacitor (LC) harmonic resonance network 30, a first capacitor C3 and a second capacitor C4. Herein the transformer Tr has a primary winding P1 and a secondary winding P2, and the primary winding P1 is used to receive the input voltage Vin. The flyback diode D5 is coupled to the secondary winding P2 of the transformer Tr. A first end of the first switch Q2 is coupled to the secondary winding P2 of the transformer Tr via the flyback diode D5, and a second end of the first switch Q2 is coupled to the primary winding P2 of the transformer Tr through a diode D6. The second switch Q3 is coupled to the secondary winding P2 of the transformer Tr. The LC harmonic resonance network 30 is coupled to the first switch Q2, the second switch Q3 and the lamp. The first capacitor C3 is coupled to the first switch Q2 and the LC harmonic resonance network 30. The second capacitor C4 is coupled to the second switch Q3 and the LC harmonic resonance network 30. Furthermore, FIG. 15 shows a diagram of another single-level architecture combining the converter and inverting according to the present invention. The single-level architecture 4 illustrated in FIG. 15 is single-level architecture 4 derived from the simplification of the boost converter (not shown) and the half-bridge serial connection harmonic resonance inverter 26. The depicted single-level architecture 4 comprises a first switch Q2, a secondary switch Q3, an energy storage inductor L, an LC harmonic resonance network 40, a first capacitor C3 and a second capacitor C4. Herein the second switch Q3 is coupled in series to the first switch Q2. A first end of the energy storage inductor L receives the input voltage Vin, and a second end of the energy storage inductor L is coupled to a mid-point between the first switch Q2 and the second switch Q3. The LC harmonic resonance network 40 is coupled to the mid-point between the first switch Q2 and the second switch Q3 as well as to the lamp. The first capacitor C3 is coupled to the first switch Q2 and the LC harmonic resonance network 40. The second capacitor C4 is coupled to the second switch Q3 and the LC harmonic resonance network 40.

In summary, the phase-control dimming electronic ballast system and the control method thereof according to the present invention, upon light dimming operation, uses the modulation DC chain voltage and switching frequency of the inverter as control of dimming, so as to expand dimming range and also prevent problems concerning poor dimming linearity or non zero voltage switching caused by merely using either frequency modulation or voltage modulation method, which empirically substantiates the feasibility of the proposed method in the present disclosure. Besides, by properly controlling duty cycle and switching frequency, it is also possible to perform power factor correction, wherein each protection means for the aforementioned control and modulation as well as the system is accomplished by the system controller, so as to digitalize complicated control mechanism and control circuit, allowing integration into a compact system.

As descriptions illustrated supra present simply the preferred embodiments of the present invention, it should be noted that the characteristics of the present invention are by no means limited thereto. All changes or modifications which any persons skilled in the relevant arts can conveniently consider within the field of the present invention are deemed to be encompassed in the scope of the present invention.

What is claimed is:

1. A phase-control dimming electronic ballast system, used for linearly adjusting the brightness of a fluorescent lamp, comprising:
a phase controller, which adjusts the magnitude and waveform of an AC voltage based on a phase firing angle;
a system controller, which is coupled to the phase controller, the system controller is used for detecting the phase firing angle and outputting a first high frequency PWM signal and a second high frequency PWM signal based on the detected phase firing angle;
a rectifier, which is coupled to the phase controller, the rectifier is used for AC voltage rectification and outputting a rectified input voltage;
a converter, which is coupled between the system controller and the rectifier, the converter is controlled by the first high frequency PWM signal and is used for modulating the rectified input voltage into a direct current (DC) bus voltage by means of voltage modulation approach; and
an inverter, which is coupled to the system controller, the converter and the lamp, the inverter is controlled by the second high frequency PWM signal and is used for modulating the DC bus voltage into a lamp voltage through frequency modulation approach for use by the lamp.

2. The phase-control dimming electronic ballast system according to claim 1, wherein the phase controller comprises a variable resistor and a thyristor based TRIAC, in which the phase controller changes the thyristor based TRIAC to trigger an AC voltage Vac on each half cycle of the phase firing angle by adjusting the variable resistor VR, or, through remote approach, controls its phase firing angle in conjunction with the system controller.

3. The phase-control dimming electronic ballast system according to claim 1, wherein the inverter is a half-bridge serial connection resonance inverter, and the half-bridge serial connection resonance inverter is connected in parallel to the lamp.

4. The phase-control dimming electronic ballast system according to claim 3, wherein the converter is a flyback converter.

5. The phase-control dimming electronic ballast system according to claim 3, wherein the converter is a boost converter.

6. The phase-control dimming electronic ballast system according to claim 1, wherein the system controller is coupled to a buzzer and the system controller controls the buzzer to act upon the phase firing angle being greater than a critical angle.

7. The phase-control dimming electronic ballast system according to claim 1, wherein the first high frequency PWM signal controls the duty cycle of the power switch in the converter, in order to modulate the magnitude of the DC bus voltage.

8. The phase-control dimming electronic ballast system according to claim 7, wherein the power switch has a zero-voltage switching feature.

9. The phase-control dimming electronic ballast system according to claim 1, wherein the second high frequency PWM signal controls the switching frequency of the power switch in the inverter, so as to modulate the magnitude of the lamp voltage.

10. A control method for phase-control light dimming, used to linearly adjust the brightness of a lamp, comprising:
modulating an input rectified voltage into a DC bus voltage in a voltage modulation approach based on a phase firing angle of the input voltage; and
modulating the DC chain bus voltage into a lamp voltage in a frequency modulation approach based on the phase firing angle, so as to linearly adjust the brightness of the lamp.

11. The control method for phase-control light dimming according to claim 10, wherein, before the step of modulating an input voltage into a DC bus voltage in a voltage modulation approach based on a phase firing angle of the input voltage, further comprising:
modulating the input voltage into an initial DC bus voltage in a voltage modulation approach based on an initial phase firing angle of the input voltage;
modulating the initial DC bus voltage into a preheating lamp voltage in a frequency modulation approach based on the initial phase firing angle for preheating the lamp; and
after a period of preheating, modulating the initial DC bus voltage into a startup lamp voltage in a frequency modulation approach so as to illuminate the lamp.

12. The phase-control dimming electronic ballast system according to claim 4, wherein the half-bridge serial connection resonance inverter and the flyback converter form a single-stage architecture, which the single-stage architecture comprises:
a transformer, which has a primary winding and a secondary winding, and the primary winding receives the input voltage;
a flyback diode, which is coupled to the secondary winding of the transformer;
a first switch, whose first end is coupled to the secondary winding of the transformer via the flyback diode, and a second end of the first switch is coupled to the primary winding of the transformer through a diode;
a second switch, which is coupled to the secondary winding of the transformer;
an LC resonance network, which is coupled to the first switch, the second switch and the lamp;
a first capacitor, which is coupled to the first switch and the LC resonance network; and
a second capacitor, which is coupled to the second switch and the LC resonance network.

13. The phase-control dimming electronic ballast system according to claim 5, wherein the half-bridge serial connection resonance inverter and the boost converter form a single-stage architecture, which the single-stage architecture comprises:
a first switch;
a second switch, which is coupled in series to the first switch;
an energy storage inductor, whose first end receives the input voltage, and a second end of the energy storage inductor is coupled to a mid-point between the first switch and the second switch;
an LC resonance network, which is coupled to the mid-point between the first switch and the second switch as well as to the lamp;
a first capacitor, which is coupled to the first switch and the LC resonance network; and
a second capacitor, which is coupled to the second switch and the LC resonance network.
